(19) United States
(12) Patent Application Publication
(10) Pub. No.: US 2023/0328730 A1
(43) Pub. Date: Oct. 12, 2023

(54) TERMINAL, RADIO COMMUNICATION METHOD, AND BASE STATION

(71) Applicant: NTT DOCOMO, INC., Tokyo (JP)

(72) Inventors: Shinya Kumagai, (US); Yuki Takahashi, (US); Satoshi Nagata, Tokyo (JP)

(73) Assignee: NTT DOCOMO, INC., Tokyo (JP)

(21) Appl. No.: 18/044,695

(22) PCT Filed: Sep. 25, 2020
(86) PCT No.: PCT/JP2020/036350

§ 371 Date: Mar. 9, 2023

(51) Int. Cl. H04W 72/1273; H04W 72/11; H04W 72/232; H04L 1/1812

(52) U.S. Cl. CPC H04W 72/1273; H04W 72/11; H04W 72/232; H04L 1/1812

(57) ABSTRACT

A terminal according to an aspect of the present disclosure includes: a reception section configured to receive information related to a downlink shared channel (PDSCH) by semi-persistent scheduling (SPS) in which transmission is not performed, using downlink control information (DCI); and a control section configured to control transmission of a hybrid automatic repeat request acknowledgement (HARQ-ACK) for the PDSCH by the SPS on a basis of the information. According to one aspect of the present disclosure, it is possible to suitably transmit and receive an HARQ-ACK corresponding to a PDSCH by semi-persistent scheduling.

### TECHNICAL FIELD

The present disclosure relates to a terminal, a radio communication method, and a base station in next-generation mobile communication systems.

### BACKGROUND ART

In a universal mobile telecommunications system (UMTS) network, specifications of long term evolution (LTE) have been drafted for the purpose of further increasing data rates, providing low latency, and the like (Non Patent Literature 1). In addition, the specifications of LTE-Advanced (3GPP Rel. 10 to 14) have been drafted for the purpose of further increasing capacity and advancement of LTE (third generation partnership project (3GPP) release (Rel.) 8 and 9).

Successor systems to LTE (for example, also referred to as 5th generation mobile communication system (5G), 5G+(plus), 6th generation mobile communication system (6G), New Radio (NR), or 3GPP Rel. 15 and subsequent releases) are also being studied.

### CITATION LIST

### Non Patent Literature

Non Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April 2010

### SUMMARY OF INVENTION

### Technical Problem

In Rel. 15 and 16 NR, in reception of a downlink (DL) channel (for example, a downlink shared channel (for example, PDSCH)) by semi-persistent scheduling (SPS) by a user terminal (user terminal, user equipment (UE)), a hybrid automatic repeat request acknowledgement (HARQ-ACK) corresponding to an SPS PDSCH that is not actually transmitted is also transmitted. Thus, for Rel. 17, from a viewpoint of reducing payload (size) of the HARQ-ACK for the SPS PDSCH, omission of transmission of the HARQ-ACK for the SPS PDSCH that is not actually transmitted has been studied.

However, how to notify the UE of the SPS PDSCH that is not actually transmitted is not sufficiently studied. Also, a method of transmitting a plurality of HARQ-ACKs including an HARQ-ACK for an SPS PDSCH that is not actually transmitted is not sufficiently studied. If these are not clarified, appropriate communication between a network (NW, e.g. base station (gNB)) and the UE cannot be performed, and communication throughput may decrease.

It is therefore an object of the present disclosure to provide a terminal, a radio communication method, and a base station capable of suitably transmitting and receiving an HARQ-ACK corresponding to a PDSCH by semi-persistent scheduling.

### Solution to Problem

A terminal according to an aspect of the present disclosure includes: a reception section configured to receive information related to a downlink shared channel (PDSCH) by semi-persistent scheduling (SPS) in which transmission is not performed, using downlink control information (DCI); and a control section configured to control transmission of a hybrid automatic repeat request acknowledgement (HARQ-ACK) for the PDSCH by the SPS on the basis of the information.

### Advantageous Effects of Invention

According to one aspect of the present disclosure, it is possible to suitably transmit and receive an HARQ-ACK corresponding to a PDSCH by semi-persistent scheduling.

### BRIEF DESCRIPTION OF DRAWINGS

FIG. 1 is a view illustrating an example of transmission control of an HARQ-ACK for an SPS PDSCH.

FIG. 2 is a view illustrating another example of transmission control of the HARQ-ACK for the SPS PDSCH.

FIG. 3 is a view illustrating an example of skipping of the SPS PDSCH.

FIG. 4 is a view illustrating another example of skipping of the SPS PDSCH.

FIG. 5 is a view illustrating an example of transmission of the HARQ-ACK to a skipped/non-skipped SPS PDSCH.

FIG. 6 is a view illustrating an example of a transmission method of the HARQ-ACK for a non-skipped SPS PDSCH and the HARQ-ACK for a DG-PDSCH according to a fourth embodiment.

FIG. 7 is a view illustrating an example of a schematic configuration of a radio communication system according to one embodiment.

FIG. 8 is a view illustrating an example of a configuration of a base station according to one embodiment.

FIG. 9 is a view illustrating an example of a configuration of a user terminal according to one embodiment.

FIG. 10 is a view illustrating an example of a hardware configuration of the base station and the user terminal according to one embodiment.

### DESCRIPTION OF EMBODIMENTS

(Semi-Persistent Scheduling)

In NR, semi-persistent scheduling (SPS) configured by higher layer signaling (for example, RRC signaling) is supported. The SPS may be configured for each serving cell, for each bandwidth part (BWP), or for each carrier. For example, activation/deactivation of a DL SPS may be separately controlled between cells, between BWPs, or between carriers.

In the present disclosure, the higher layer signaling may be any of, for example, radio resource control (RRC) signaling, medium access control (MAC) signaling, broadcast information, and the like, or a combination thereof.

For example, a MAC control element (MAC CE), a MAC protocol data unit (PDU), or the like, may be used for the MAC signaling. The broadcast information may be, for example, a master information block (MIB), a system information block (SIB), remaining minimum system information (RMSI), other system information (OSI), or the like.

The physical layer signaling may be, for example, downlink control information (DCI).

The DL SPS may be applied to a downlink shared channel (PDSCH). In this case, activation/deactivation of the PDSCH may be instructed by a physical downlink control channel (PDCCH)) (or DCI). The deactivation may be read as release. In a case where the activation of the DL SPS is instructed by the PDCCH, the UE may control reception operation of the semi-persistent PDSCH whose transmission/allocation is controlled using a specific transmission condition. The reception operation may be read as monitoring, decoding processing, or demodulation processing of a PDCCH (or DCI).

The transmission condition/transmission parameter to be applied to the semi-persistent PDSCH may be configured by higher layer signaling/physical layer signaling. The parameter to be applied to the semi-persistent PDSCH may be referred to as SPS configuration information.

In the NR Rel. 16, the SPS configuration information (for example, SPS-Config) notified by the higher layer signaling may include at least one of the following:
information indicating a period (for example, periodicity),
information indicating the number of HARQ processes (for example, nrofHARQ-Processes);
information (for example, n1 PUCCH-AN) related to a resource (for example, a PUCCH resource) for an uplink control channel (for example, Physical Uplink Control Channel) to be used for transmission of an HARQ-ACK;
table information (for example, the MCS table (mcs-Table)) to be used for determining a modulation and coding scheme (MCS);
information (for example, an SPS configuration index, sps-ConfigIndex, sps-ConfigIndex-r16) indicating one of a plurality of DL SPS configurations in one BWP;
information related to an offset to be used to generate the HARQ process ID (for example, HARq-ProcID-Offset, HARq-ProcID-Offset-r16);
information for calculating a period of the SPS PDSCH (for example, periodicity Ext, periodicity Ext-r16);
information (for example, HARq-CodebookID, HARq-CodebookID-r16) indicating an HARQ-ACK codebook corresponding to an HARQ-ACK for the SPS PDSCH and an ACK for SPS PDSCH release,
Information indicating the number of repetitions of the SPS PDSCH (for example, pdsch-AggregationFactor, pdsch-AggregationFactor-r16).

At least one of the SPS activation DCI or the release DCI may include at least one piece of the following information.
Information (time domain resource assignment) regarding allocation of time domain resources (for example, one or more symbols)
Information (frequency domain resource assignment) regarding allocation of frequency domain resources (for example, one or more physical resource blocks (PRB) (also referred to as resource blocks (RB))
Information regarding the MCS (for example, an MCS index)
Information (for example, an HARQ process number (HPN) and an HARQ process ID) indicating the HARQ process
Information (for example, redundancy version (RV)) indicating a redundant version
Information (for example, a downlink assignment index (DL assignment index)) regarding the DL assignment
Information (for example, a PUCCH resource indicator) regarding the PUCCH resource
Information (for example, a PDSCH-HARQ-ACK feedback timing indicator (PDSCH-to-HARQ feedback timing indicator)) regarding timing to feed back (transmit) the HARQ-ACK
Information (for example, a carrier indicator (CI)) regarding a carrier
Information (for example, a bandwidth part indicator (BI)) regarding a bandwidth part (BWP)
New data indicator (NDI)

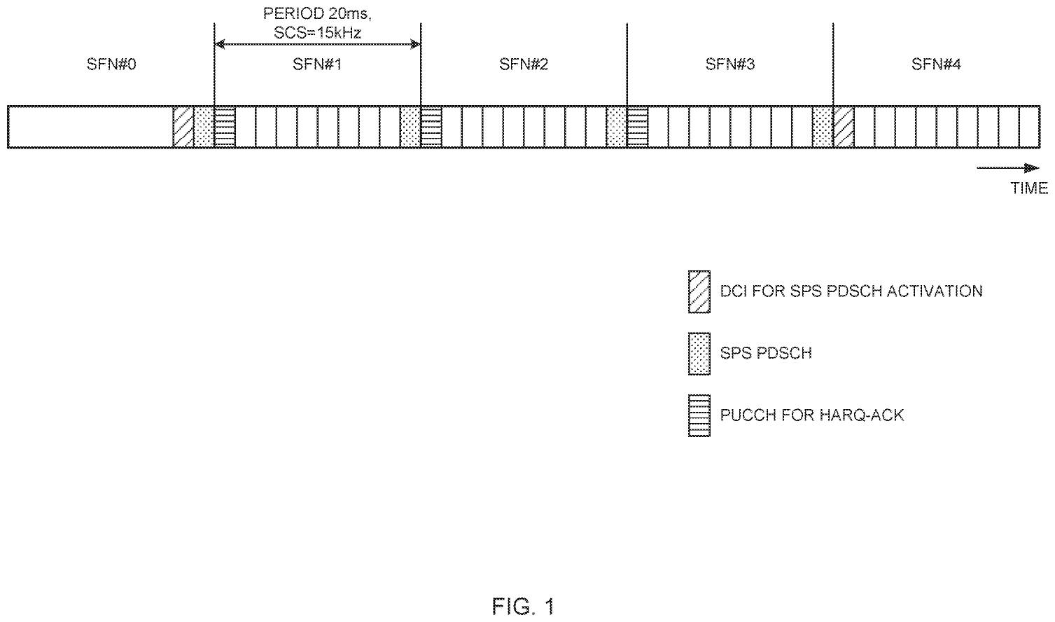

FIG. 1 illustrates an example of a case where a semi-persistent PDSCH (SPS PDSCH) is transmitted. Here, a case where a period (Periodicity) is configured to 20 ms and an applied subcarrier spacing is set to 15 kHz is illustrated, but the transmission condition of the PDSCH is not limited thereto.

In FIG. 1, the network gives an instruction to activate the SPS PDSCH by using DCI. The DCI giving an instruction to activate the SPS PDSCH may be, for example, a DCI format 1_0/1_1/1_2. In a case where the DCI is detected, the UE performs reception processing of the SPS PDSCH assuming (or expecting) that the SPS PDSCH is transmitted with a specific period.

The UE may feed back the HARQ-ACK to the SPS PDSCH. For example, the UE may transmit the HARQ-ACK for the SPS PDSCH using the PUCCH. The UE may be notified of conditions such as a transmission timing of the HARQ-ACK (or PUCCH) (for example, K0) using DCI that gives an instruction to activate the SPS PDSCH. Alternatively, conditions such as a transmission timing of the HARQ-ACK (or PUCCH) (for example, K0) may be configured in higher layer signaling (for example, dl-DataToUL-ACK).

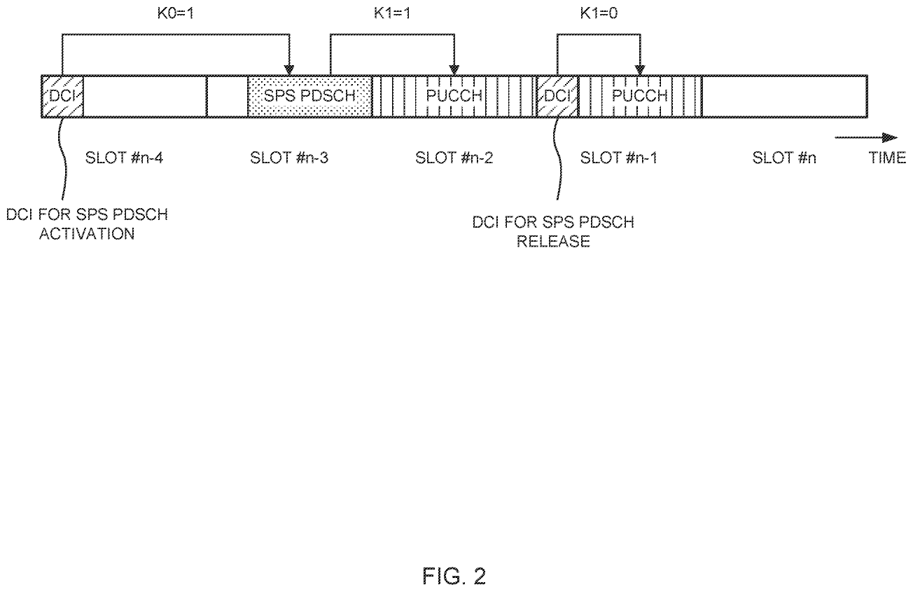

In a case where the DCI giving an instruction to deactivate the SPS PDSCH is received, the UE may control not to perform the SPS PDSCH reception processing. The UE may feed back the HARQ-ACK for the DCI giving an instruction to deactivate the SPS PDSCH. For example, the UE may transmit the HARQ-ACK for the DCI by using the PUCCH. The UE may be notified of conditions such as a transmission timing of the HARQ-ACK (or the PUCCH) (for example, Kl) using DCI giving an instruction to deactivate the SPS PDSCH (see FIG. 2).

By the way, even in a case where the reception of the SPS PDSCH is configured for the UE, there is a case where traffic of the SPS PDSCH does not actually exist. In NR prior to Rel. 16, the UE feeds back the HARQ-ACK (ACK/NACK) for each transmission occasion (opportunity) of the SPS PDSCH regardless of presence or absence of actual traffic. Thus, from the viewpoint of reducing payload (size) of the HARQ-ACK corresponding to the SPS PDSCH, it is considered in Rel. 17 or later to omit transmission of the HARQ-ACK corresponding to the SPS PDSCH that is to be actually transmitted/not transmitted.

However, how to notify the UE of a specific SPS PDSCH (for example, an SPS PDSCH that is not actually transmitted, an SPS PDSCH that does not require HARQ-ACK feedback, or the like) has not been sufficiently studied. More specifically, regarding the SPS PDSCH, it is not sufficient to consider a signal/channel to be used for notification to the UE (for example, which DCI (PDCCH) is used), how to make the notification, and at what timing the DCI (PDCCH) for making a notification of the SPS PDSCH is received. In addition, in a case where the UE is notified of the SPS PDSCH that is not actually transmitted, it is not sufficient to consider how to transmit the HARQ-ACK.

In addition, it is not sufficient to consider how to control transmission of the HARQ-ACK to the PDSCH (which may be referred to as a DG-PDSCH) to be dynamically scheduled by the SPS PDSCH and the DCI actually transmitted together with transmission control of the HARQ-ACK to the SPS PDSCH not actually transmitted. If these are not clarified, appropriate communication between the NW and the UE cannot be performed, which may lead to decrease in communication throughput.

The present inventors therefore have conceived of a suitable transmission/reception method of an HARQ-ACK corresponding to a PDSCH by semi-persistent scheduling.

Hereinafter, embodiments according to the present disclosure will be described in detail with reference to the drawings. The radio communication methods according to the embodiments may be applied alone or in combination.

Note that in the present disclosure, “A/B” may indicate “at least one of A or B”. In the present disclosure, “A/B/C” may indicate at least one of A, B, or C.

Note that, in the present disclosure, a PDSCH by SPS may be read as an SPS PDSCH, configuration grant-based transmission, DL transmission with a configuration grant, configuration scheduling, SPS transmission, a PDSCH, or the like. The specific occasion (opportunity) having a specific period to be used for reception of the SPS PDSCH by the UE or transmission by the base station may be read as an SPS opportunity, a DL SPS opportunity, a reception opportunity, a reception period, an SPS transmission opportunity, a transmission opportunity, a specific period, a specific timing, a period, or the like.

Note that, in the present disclosure, the SPS PDSCH that is not actually transmitted may be referred to as an SPS PDSCH with no traffic, an SPS PDSCH with which transmission is skipped, a skipped SPS PDSCH, an SPS PDSCH without requiring HARQ-ACK feedback, or the like.

Furthermore, in the present disclosure, the SPS PDSCH to be actually transmitted may be referred to as an SPS PDSCH with traffic, an SPS PDSCH in which transmission is not skipped, a non-skipped SPS PDSCH, an SPS PDSCH in which HARQ-ACK feedback is required, or simply an SPS PDSCH.

(Radio Communication Method)

### First Embodiment

In a first embodiment, a method for instructing a UE on a skipped SPS PDSCH using DCI (PDCCH) will be described. The UE may be notified of/instructed on the skipped SPS PDSCH on the basis of specific DCI. The specific DCI may be DCI described in at least one of Embodiments 1-1 and 1-2 below.

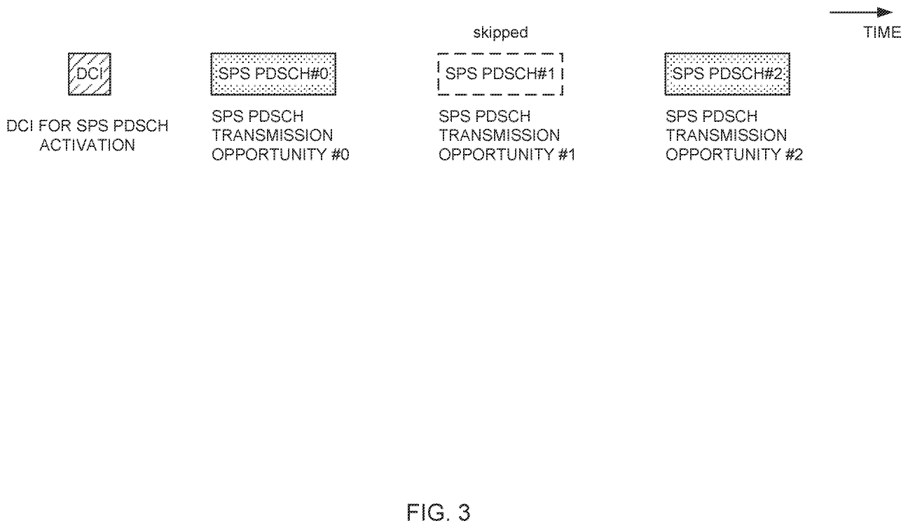

FIG. 3 is a view illustrating an example of skipping of the SPS PDSCH. In the example of FIG. 3, the UE receives the DCI to activate the SPS PDSCH. Then, the UE receives the SPS PDSCH in a transmission opportunity (here, the SPS PDSCH transmission opportunities #0 to #2) configured with a specific period.

In the example of FIG. 3, there is actual traffic for an SPS PDSCH #0 and an SPS PDSCH #2 in the transmission opportunity #0 and the transmission opportunity #2. On the other hand, there is no actual traffic for an SPS PDSCH #1 in the transmission opportunity #1. In this event, the network notifies the UE that the SPS PDSCH has been skipped.

### Embodiment 1-1

The UE may be notified of/instructed on a skipped SPS PDSCH by a DCI format that schedules the PDSCH. The DCI format may be, for example, a DCI format 1_0/1_1/1_2 defined in Rel. 15 or 16. In a case where the UE is notified of/instructed on the skipped SPS PDSCH by the DCI format, the UE may skip/cancel/omit transmission of the HARQ-ACK to the skipped SPS PDSCH.

The DCI format may include a field for making a notification/instruction of the skipped SPS PDSCH. The field may be included in the DCI format when the UE is configured/instructed to skip the HARQ-ACK for the skipped SPS PDSCH. Furthermore, the field may be included in the DCI format when the skipped SPS PDSCH is configured for the UE by higher layer signaling.

Furthermore, the DCI format may include a field of a flag for making a notification/instruction of the skipped SPS PDSCH. The flag field may be a field indicating that the DCI including the flag field is either the scheduling DCI or the DCI making a notification of the skipped SPS PDSCH. The flag field may be included in the DCI format when the UE is configured/instructed to skip the HARQ-ACK for the skipped SPS PDSCH.

When a bit value of the flag field is the first value (for example, 0), the UE may be notified/instructed to schedule the PDSCH/non-skipped SPS PDSCH. Further, when the bit value of the flag field is the second value (for example, 1), the UE may be notified of/instructed on the skipped PDSCH.

Further, when the bit value of the flag field is the second value (for example, 1), a field making a notification/instruction of the skipped SPS PDSCH may be included in the DCI included in the flag field. In other words, when the bit value of the flag field is the second value (for example, 1), the UE may determine that the field making a notification/instruction of the skipped SPS PDSCH is included in the DCI included in the flag field.

### Modifications of Embodiment 1-2

The UE may be notified of/instructed on the skipped SPS PDSCH by the DCI format which activates/releases the SPS PDSCH. When the UE is notified of/instructed on the skipped SPS PDSCH by the DCI format, the UE may skip transmission of the HARQ-ACK to the skipped SPS PDSCH.

The DCI format may include a field for making a notification/instruction of the skipped SPS PDSCH. The field may be included in the DCI format when the UE is configured/instructed to skip the HARQ-ACK for the skipped SPS PDSCH. Furthermore, the field may be included in the DCI format when the skipped SPS PDSCH is configured for the UE by higher layer signaling.

Furthermore, the DCI format may include a field of a flag for making a notification/instruction of the skipped SPS PDSCH. The flag field may be a field indicating that the DCI including the flag field is either the scheduling DCI or the DCI making a notification of the skipped SPS PDSCH. The flag field may be included in the DCI format when the UE is configured/instructed to skip the HARQ-ACK for the skipped SPS PDSCH.

When a bit value of the flag field is the first value (for example, 0), the UE may be notified/instructed to schedule the PDSCH/non-skipped SPS PDSCH. Further, when the bit value of the flag field is the second value (for example, 1), the UE may be notified of/instructed on the skipped PDSCH.

Further, when the bit value of the flag field is the second value (for example, 1), a field making a notification/instruction of the skipped SPS PDSCH may be included in the DCI included in the flag field. In other words, when the bit value of the flag field is the second value (for example, 1), the UE may determine that the field making a notification/instruction of the skipped SPS PDSCH is included in the DCI included in the flag field.

### Embodiment 1-2

The UE may be notified of/instructed on the skipped SPS PDSCH by a newly defined DCI format. The DCI format may be represented by, for example, a DCI format X_Y (where X and Y are arbitrary integers or symbols). When the UE is notified of/instructed on the skipped SPS PDSCH by the DCI format, the UE may skip transmission of the HARQ-ACK to the skipped SPS PDSCH.

The DCI format may be a DCI format to be used for notification of the skipped SPS PDSCH. Further, the DCI format may be a DCI format for other uses.

The DCI format may be transmitted by a UE-dedicated PDCCH. In this event, the DCI format may include a field for making a notification/instruction of the skipped SPS PDSCH.

Furthermore, the DCI format may be transmitted by a group-common PDCCH. In this event, the DCI format may include a field for making a notification/instruction of the skipped SPS PDSCH. In addition, a bit position giving an instruction of the skipped SPS PDSCH for each UE may be configured by higher layer signaling. The group may mean a PDSCH group.

As described above, according to the first embodiment, the DCI for making a notification of the skipped SPS PDSCH can be appropriately configured, and the UE can be suitably notified of the non-skipped/skipped SPS PDSCH.

### Second Embodiment

In a second embodiment, parameters/fields for notifying/instructing the UE of the skipped SPS PDSCH will be described. The UE may judge/determine the skipped SPS PDSCH on the basis of at least one of the parameters/fields included in the DCI. The parameters/fields included in the DCI may be those described in Embodiments 2-1 to 2-3 below.

A parameter/field notification method for making a notification/instruction of the skipped SPS PDSCH in this embodiment may be according to at least one of the methods described in the first embodiment.

### Embodiment 2-1

The UE may determine the skipped SPS PDSCH on the basis of information related to the notified HARQ process number (HPN). In other words, the UE may be notified of the HPN indicating the skipped SPS PDSCH.

The information related to the HPN indicating the skipped SPS PDSCH, the UE is notified of may be a bitmap indicating a plurality of (for example, all) HARQ processes (Embodiment 2-1-1). In Embodiment 2-1-1, if each bit value of the bitmap is a first value (for example, 0), the UE may determine that the corresponding SPS PDSCH is not skipped, and if each bit value of the bitmap is a second value (for example, 1), the UE may determine that the corresponding SPS PDSCH is skipped.

Note that the HARQ processes may be HARQ processes configured for each SPS configuration.

In addition, the information related to the HPN indicating the skipped SPS PDSCH may be an index indicating the HPN (Embodiment 2-1-2).

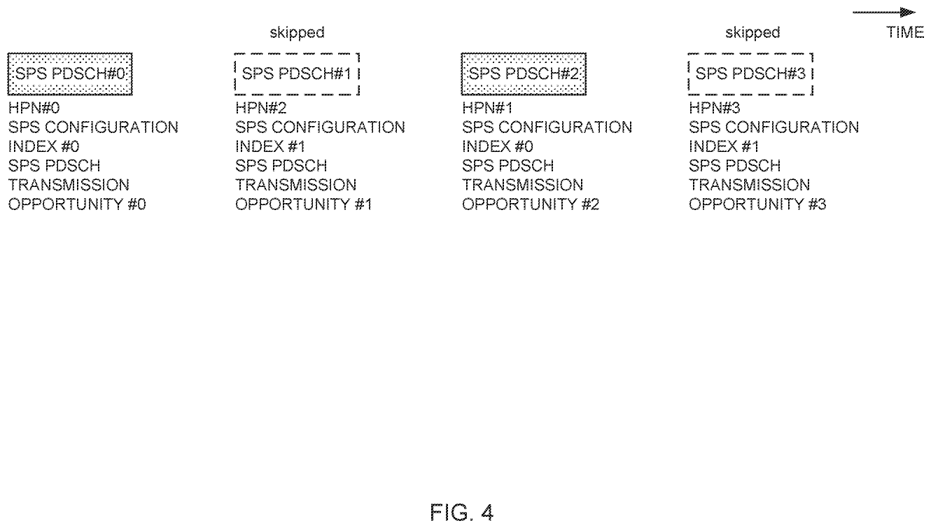

FIG. 4 is a view illustrating another example of skipping of the SPS PDSCH. In FIG. 4, the SPS PDSCH transmission opportunities #0 to #3 are configured. HPN #0 and an SPS configuration index #0 are configured for the SPS PDSCH #0 in the SPS PDSCH transmission opportunity #0. HPN #2 and an SPS configuration index #1 are configured for the SPS PDSCH #1 in the SPS PDSCH transmission opportunity #1. HPN #1 and the SPS configuration index #0 are configured for the SPS PDSCH #2 in the SPS PDSCH transmission opportunity #2. HPN #3 and the SPS configuration index #1 are configured for the SPS PDSCH #3 in the SPS PDSCH transmission opportunity #3. In the example of FIG. 4, transmission of the SPS PDSCH #1 and #3 is skipped.

Note that resources of the SPS PDSCH transmission opportunity, the values of the HPN and the SPS configuration index, and the like, in the drawings of the present disclosure are merely examples, and are not limited thereto. For example, if a different SPS configuration index (SPS-configIndex) is configured, a configuration may be supported/allowed in which the transmission of the different SPS configuration indexes (for example, transmission opportunity #0 and transmission opportunity #1) is skipped. In addition, a configuration may be supported in which transmission of SPS configuration indexes corresponding to some transmission opportunities among the same SPS configuration indexes corresponding to different transmission opportunities is skipped.

When Embodiment 2-1-1 is applied to the case of FIG. 4, the UE may be notified of a bitmap of HPN “0011 (or 1100)” indicating the skipped SPS PDSCH.

Note that correspondence between each position of the bitmap and each parameter/field in the present embodiment is merely an example, and the present invention is not limited thereto. In addition, the upper and lower levels of the bitmap in the present embodiment are merely for convenience and are not limited thereto.

In addition, when Embodiment 2-1-2 is applied to the case of FIG. 4, the UE may be notified of 2 and 3, which are indexes of HPN indicating the skipped SPS PDSCH.

### Embodiment 2-2

The UE may determine the skipped SPS PDSCH on the basis of information related to the notified SPS configuration index. In other words, the UE may be notified of information related to the SPS configuration index indicating the skipped SPS PDSCH.

The information related to the SPS configuration index indicating the skipped SPS PDSCH, the UE is notified of may be a bitmap indicating a plurality of (for example, all) SPS configuration indexes (Embodiment 2-2-1). In Embodiment 2-2-1, if each bit value of the bitmap is a first value (for example, 0), the UE may determine that the corresponding SPS PDSCH is not skipped, and if each bit value of the bitmap is a second value (for example, 1), the UE may determine that the corresponding SPS PDSCH is skipped.

Note that the SPS configuration index may be a SPS configuration index set for each SPS configuration.

Furthermore, the information on the SPS configuration index indicating the skipped SPS PDSCH may be an index indicating the SPS configuration index (Embodiment 2-2-2).

When Embodiment 2-2-1 is applied to the case of FIG. 4, the UE may be notified of the bitmap of the SPS configuration index “01 (or 10)” indicating the skipped SPS PDSCH.

In addition, when Embodiment 2-2-2 is applied to the case of FIG. 4, the UE may be notified of 1, which is the SPS configuration index indicating the skipped SPS PDSCH.

Note that, in Embodiment 2-2, the UE does not have to assume that only some of the SPS PDSCH among the plurality of SPS PDSCH corresponding to the same SPS configuration index are skipped.

### Embodiment 2-3

The UE may determine the skipped SPS PDSCH on the basis of the notified information related to the SPS PDSCH transmission opportunity. In other words, the UE may be notified of the information related to the SPS PDSCH transmission opportunity indicating the skipped SPS PDSCH.

The information related to the SPS PDSCH transmission opportunities indicating the skipped SPS PDSCH, the UE is notified of may be a bitmap indicating a plurality of (for example, all) SPS PDSCH transmission opportunities (Embodiment 2-3-1). In Embodiment 2-3-1, if each bit value of the bitmap is a first value (for example, 0), the UE may determine that the corresponding SPS PDSCH is not skipped, and if each bit value of the bitmap is a second value (for example, 1), the UE may determine that the corresponding SPS PDSCH is skipped.

Furthermore, the information regarding the SPS PDSCH transmission opportunity indicating the skipped SPS PDSCH may be an index indicating the SPS PDSCH transmission opportunity (Embodiment 2-3-2).

When Embodiment 2-3-1 is applied to the case of FIG. 4, the UE may be notified of the bitmap of the SPS configuration index “0101 (or 1010)” indicating the skipped SPS PDSCH.

In addition, when Embodiment 2-3-2 is applied to the case of FIG. 4, the UE may be notified of SPS configuration indexes 1 and 3 indicating the skipped SPS PDSCH.

As described above, according to the second embodiment, it is possible to appropriately set the parameters/fields included in the DCI for making a notification of the skipped SPS PDSCH, and it is possible to flexibly control the notification of the non-skipped/skipped SPS PDSCH.

### Third Embodiment

In a third embodiment, a time relationship between a reception timing of the DCI for making a notification of the skipped SPS PDSCH and a feedback timing of the HARQ-ACK for the non-skipped/skipped SPS PDSCH by the UE will be described.

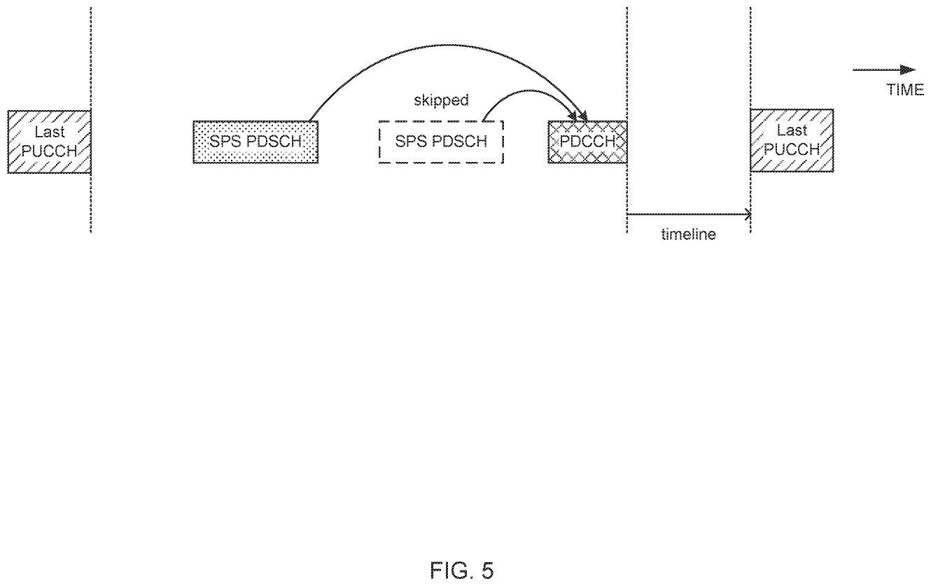

As illustrated in FIG. 5, the present embodiment assumes a case where the HARQ-ACK for the non-skipped/skipped SPS PDSCH after transmission of a certain HARQ-ACK (last PUCCH) is transmitted after a lapse of certain time (timeline) from the last symbol of the PDCCH including the DCI for making a notification of the skipped SPS PDSCH. In other words, the UE does not have to assume that a time interval between the head symbol of the PUCCH including the HARQ-ACK for the non-skipped/skipped SPS PDSCH and the last symbol of the PDCCH including the DCI for making a notification of the skipped SPS PDSCH is shorter than a constant value (timeline). The UE may transmit the HARQ-ACK for the non-skipped/skipped SPS PDSCH reflecting the skipped SPS PDSCH notified by the DCI for making a notification of the skipped SPS PDSCH. The UE may determine the time relationship between the reception timing of the DCI for making a notification of the skipped SPS PDSCH and the feedback timing of the HARQ-ACK for the non-skipped/skipped SPS PDSCH according to Embodiments 3-1 to 3-3 below.

Note that the certain HARQ-ACK may be an arbitrary HARQ-ACK in the PUCCH transmitted last, or may be an HARQ-ACK transmitted last for the SPS PDSCH.

The UE may transmit the HARQ-ACK by using one or more transmission resources. In transmitting the HARQ-ACK, the UE may transmit one or more HARQ-ACKs for the PDSCH including one or more non-skipped/skipped SPS PDSCH in one PUCCH/PUSCH resource.

### Embodiment 3-1

The UE may determine the time relationship between the reception timing of the DCI for making a notification of the skipped SPS PDSCH and the feedback timing of the HARQ-ACK for the non-skipped/skipped SPS PDSCH on the basis of the PDCCH for releasing the SPS PDSCH and the corresponding timeline of the HARQ-ACK. In other words, the HARQ-ACK for the non-skipped/skipped SPS PDSCH may be transmitted N symbols after the last symbol of the PDCCH including the DCI for making a notification of the skipped SPS PDSCH.

The N may depend on a value of a specific parameter (for example, p). The p may be a parameter corresponding to the configuration of the subcarrier spacing (SCS Configuration) of the PDCCH including the DCI for making a notification of the skipped SPS PDSCH, may be a parameter corresponding to the configuration of the subcarrier spacing of the PUCCH carrying the HARQ-ACK information for the non-skipped/skipped SPS PDSCH, or may be a parameter corresponding to the configuration of the minimum subcarrier spacing between the two.

Note that N may be determined/calculated on the basis of a method defined in an existing system (for example, Rel. 15). For example, for the UE of the UE processing capability 1, N=10 when the subcarrier spacing is 15 kHz, N=12 when the subcarrier spacing is 30 kHz, N=22 when the subcarrier spacing is 60 kHz, and N=25 when the subcarrier spacing is 120 kHz; or for UE of the UE processing capability 2, N=5 when the subcarrier spacing is 15 kHz, N=5.5 when the subcarrier spacing is 30 kHz, and N=11 when the subcarrier spacing is 60 kHz.

### Embodiment 3-2

The UE may determine the time relationship between the reception timing of the DCI for making a notification of the skipped SPS PDSCH and the transmission timing of the HARQ-ACK for the non-skipped/skipped SPS PDSCH on the basis of the transmission timing of the HARQ-ACK according to the scheduling DCI (for example, PDSCH-to-HARQ feedback timing indicator).

For example, the UE may transmit a PUCCH in a case where there is a certain period or more between a PDCCH including the DCI for making a notification of a skipped SPS PDSCH and a physical uplink control channel (for example, the head symbol of the PUCCH) for transmitting the HARQ-ACK. The certain period (for example, the specific symbol) may be determined on the basis of the parameter (N1) determined on the basis of at least one of the subcarrier spacing, the UE capability, or presence or absence of the additional DMRS and the parameter (d1,1) determined on the basis of at least one of the mapping type or the UE capability. For example, the certain period may be N₁+d_{1,1} symbols.

Note that N₁ and d_{1,1} may be determined/calculated on the basis of a method defined in an existing system (for example, Rel. 15).

### Embodiment 3-3

The UE may start transmitting the HARQ-ACK to the non-skipped/skipped SPS PDSCH after M or more symbols from the last symbol of the PDCCH including the DCI for making a notification of the skipped SPS PDSCH. In other words, the UE may assume that the period between the last symbol of the certain PDCCH and the start symbol of the channel (PUCCH/PUSCH) transmitting the HARQ-ACK is M symbols or more.

The M may be different for each subcarrier spacing. M may be defined in the specification, may be configured/instructed from the NW to the UE by at least one of higher layer signaling or physical layer signaling, or may depend on the UE capability.

According to the third embodiment described above, even in a case where the SPS PDSCH is skipped, the transmission timing of the HARQ-ACK for the SPS PDSCH can be determined.

### Fourth Embodiment

In a fourth embodiment, a transmission control method of the HARQ-ACK for the PDSCH (DG-PDSCH) to be dynamically scheduled by the non-skipped SPS PDSCH and the DCI in a case where the HARQ-ACK for the skipped SPS PDSCH is skipped by the UE will be described.

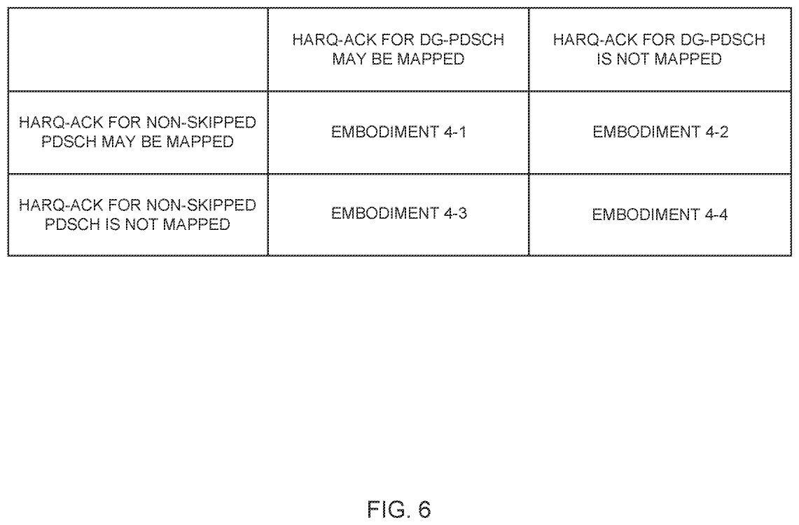

In this embodiment, in a case where the HARQ-ACK is skipped for the skipped SPS PDSCH, cases of the following Embodiments 4-1 to 4-4 are considered (see FIG. 6):
a case in which the HARQ-ACK for the non-skipped SPS PDSCH and the HARQ-ACK for the DG-PDSCH may be mapped in a certain resource (Embodiment 4-1);
a case in which the HARQ-ACK for the DG-PDSCH is not mapped in a certain resource and the HARQ-ACK for the non-skipped SPS PDSCH may be mapped (Embodiment 4-2);
a case in which the HARQ-ACK for the non-skipped SPS PDSCH is not mapped and the HARQ-ACK for the DG-PDSCH may be mapped in a certain resource (Embodiment 4-3);
a case where neither the HARQ-ACK for the non-skipped SPS PDSCH nor the HARQ-ACK for the DG-PDSCH is mapped in a certain resource (Embodiment 4-4).

The certain resource may be a resource configured/instructed to transmit the HARQ-ACK in a case where the HARQ-ACK for the skipped SPS PDSCH is not skipped. The “PUCCH/PUSCH” in the present embodiment may mean “PUCCH/PUSCH configured/instructed to transmit the HARQ-ACK to the skipped SPS PDSCH”.

Note that, in the present embodiment, the HARQ-ACK for release of the SPS PDSCH may follow the transmission method of the HARQ-ACK of the DG-PDSCH described below.

Further, in the present embodiment, transmission/skipping of the HARQ-ACK will be described as the uplink control information (UCI), but the present embodiment may be applied to a case where the UCI (CG-UCI) based on the scheduling request (SR), the channel state information (CSI), and the configuration grant is not mapped/multiplexed on the PUSCH/PUCCH resource.

Furthermore, the present embodiment will be described on the assumption that the HARQ-ACK is skipped for the skipped SPS PDSCH, but the present embodiment can be appropriately applied to a case where the HARQ-ACK is not skipped for the skipped SPS PDSCH.

Note that, in the present disclosure, the HARQ-ACK for the skipped SPS PDSCH, the HARQ-ACK for the non-skipped SPS PDSCH, and the HARQ-ACK for the DG-PDSCH may be read as each other.

### Embodiment 4-1

In Embodiment 4-1, a case where the HARQ-ACK for the non-skipped SPS PDSCH and the HARQ-ACK for the DG-PDSCH can be mapped in a certain PUCCH/PUSCH will be described.

In this case, the UE may map and transmit the HARQ-ACK for the non-skipped SPS PDSCH and the HARQ-ACK for the DG-PDSCH in the PUCCH/PUSCH (Embodiment 4-1-1).

Furthermore, in this case, if the HARQ-ACKs for a plurality of (for example, all) non-skipped SPS PDSCH are negative acknowledgements (NACK), the UE may map and transmit the HARQ-ACK for the DG-PDSCH in the PUCCH/PUSCH without mapping (dropping) the HARQ-ACK (NACK) for the non-skipped SPS PDSCH. Otherwise, the UE may map and transmit the HARQ-ACK for the non-skipped SPS PDSCH and the HARQ-ACK for the DG-PDSCH in the PUCCH/PUSCH (Embodiment 4-1-2).

Furthermore, in this case, in a case where the HARQ-ACKs for a plurality of (for example, all) non-skipped SPS PDSCH are acknowledgements (ACK), the UE may map and transmit the HARQ-ACK for the DG-PDSCH without mapping (dropping) the HARQ-ACK (ACK) for the non-skipped SPS PDSCH in the PUCCH/PUSCH. Otherwise, the UE may map and transmit the HARQ-ACK for the non-skipped SPS PDSCH and the HARQ-ACK for the DG-PDSCH in the PUCCH/PUSCH (Embodiment 4-1-3).

The UE may transmit the HARQ-ACK for the skipped SPS PDSCH, the HARQ-ACK for the non-skipped SPS PDSCH, and the HARQ-ACK for the DG-PDSCH using the same codebook. If HARQ-ACK feedback is performed utilizing a dynamic HARQ-ACK codebook (for example, a Type 2 HARQ-ACK codebook), a size of the HARQ-ACK codebook can be reduced by dropping the HARQ-ACK for the non-skipped SPS PDSCH.

### Embodiment 4-2

In Embodiment 4-2, a case in which the HARQ-ACK for the DG-PDSCH is not mapped in a certain PUCCH/PUSCH and the HARQ-ACK for the non-skipped SPS PDSCH may be mapped will be described.

In this case, the UE may map and transmit the HARQ-ACK to the non-skipped SPS PDSCH in the PUCCH/PUSCH (Embodiment 4-2-1).

Furthermore, in this case, if the HARQ-ACKs for a plurality of (for example, all) non-skipped SPS PDSCH are negative acknowledgements (NACK), the UE does not have to map (may drop) the HARQ-ACK (NACK) for the non-skipped SPS PDSCH, and may skip (drop) the transmission of the PUCCH/PUSCH. Otherwise, the UE may map and transmit the HARQ-ACK to the non-skipped SPS PDSCH in the PUCCH/PUSCH (Embodiment 4-2-2).

Furthermore, in this case, in a case where the HARQ-ACK for a plurality of (for example, all) non-skipped SPS PDSCH is an acknowledgement (ACK), the UE may skip (drop) the transmission of the PUCCH/PUSCH without mapping (ACK) the HARQ-ACK for the non-skipped SPS PDSCH in the PUCCH/PUSCH. Otherwise, the UE may map and transmit the HARQ-ACK to the non-skipped SPS PDSCH in the PUCCH/PUSCH (Embodiment 4-2-3).

### Embodiment 4-3

In Embodiment 4-3, a case where the HARQ-ACK for the non-skipped SPS PDSCH is not mapped in a certain PUCCH/PUSCH, and the HARQ-ACK for the DG-PDSCH may be mapped will be described.

In this case, the UE may map and transmit the HARQ-ACK to the DG-PDSCH in the PUCCH/PUSCH.

### Embodiment 4-4

In Embodiment 4-4, a case where neither the HARQ-ACK for the non-skipped SPS PDSCH nor the HARQ-ACK for the DG-PDSCH is mapped in a certain PUCCH/PUSCH will be described.

In this case, the UE may skip (drop) transmission of the PUCCH/PUSCH.

### Modifications of Fourth Embodiment

In the above fourth embodiment, the HARQ-ACK for the DG-PDSCH is not dropped, and the HARQ-ACK for the non-skipped SPS PDSCH may be dropped.

In a case where the HARQ-ACK for the non-skipped SPS PDSCH and the HARQ-ACK for the DG-PDSCH are mapped in a certain PUCCH/PUSCH, in generating the HARQ-ACK information of the UE, the UE may generate the HARQ-ACK information for the DG-PDSCH. The HARQ-ACK information for the non-skipped SPS PDSCH may then be generated and added to the HARQ-ACK information for the DG-PDSCH.

In a case where the HARQ-ACK for the non-skipped SPS PDSCH is skipped and the HARQ-ACK for the DG-PDSCH is mapped in a certain PUCCH/PUSCH, in generating the HARQ-ACK information of the UE, the UE may generate only the HARQ-ACK information for the DG-PDSCH. Alternatively, the UE may generate the HARQ-ACK information for the DG-PDSCH, then generate the HARQ-ACK information for the non-skipped SPS PDSCH, and drop the HARQ-ACK information for the non-skipped SPS PDSCH.

In generating the HARQ-ACK information for the skipped/non-skipped SPS PDSCH and the HARQ-ACK information for the DG-PDSCH, the UE may assume the payload of the HARQ-ACK to be transmitted in a certain PUCCH/PUSCH on the basis of the number of bits of the HARQ-ACK for all the SPS PDSCH and the number of bits of the HARQ-ACK for the DG-PDSCH.

Furthermore, in generating the HARQ-ACK information for the skipped/non-skipped SPS PDSCH and the HARQ-ACK information for the DG-PDSCH, the UE may assume the payload of the HARQ-ACK to be transmitted in a certain PUCCH/PUSCH on the basis of the number of bits of the HARQ-ACK for the non-skipped SPS PDSCH and the number of bits of the HARQ-ACK for the DG-PDSCH.

According to the fourth embodiment described above, even in a case where transmission of the HARQ-ACK to the skipped/non-skipped SPS PDSCH and the PDSCH to be dynamically scheduled by the DCI are mixed, it is possible to appropriately transmit the HARQ-ACK.

### OTHERS

Note that, in a case where skipping of the HARQ-ACK transmission for the skipped SPS PDSCH is configured for the UE, and in a case where the UE does not detect the PDCCH (DCI) that makes a notification/instruction of the skipped SPS PDSCH, the UE may control transmission of the HARQ-ACK assuming that all the SPS PDSCH are not skipped.

(Radio Communication System)

Hereinafter, a configuration of a radio communication system according to one embodiment of the present disclosure will be described. In this radio communication system, communication is performed using one or a combination of radio communication methods according to the embodiments of the present disclosure.

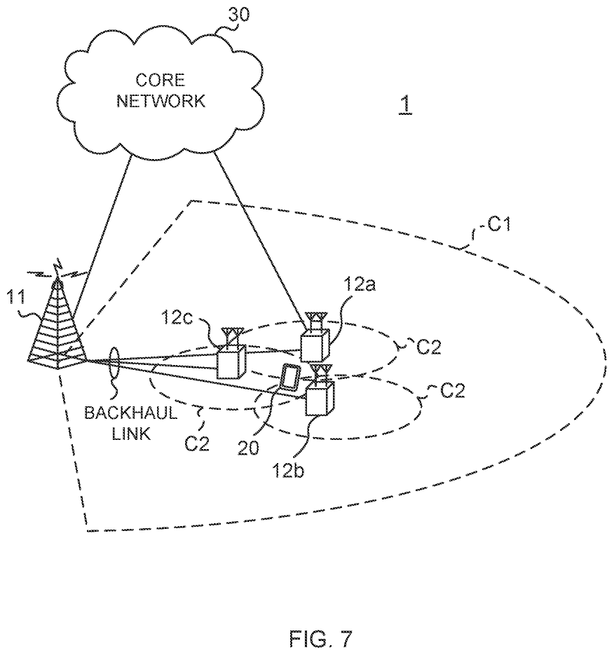

FIG. 7 is a view illustrating an example of a schematic configuration of the radio communication system according to one embodiment. A radio communication system 1 may be a system that implements communication using long term evolution (LTE), 5th generation mobile communication system New Radio (5G NR), and the like, drafted as the specification by third generation partnership project (3GPP).

Further, the radio communication system 1 may support dual connectivity (multi-RAT dual connectivity (MR-DC)) between a plurality of radio access technologies (RATs). The MR-DC may include dual connectivity between LTE (evolved universal terrestrial radio access (E-UTRA)) and NR (E-UTRA-NR dual connectivity (EN-DC)), dual connectivity between NR and LTE (NR-E-UTRA dual connectivity (NE-DC)), and the like.

In the EN-DC, an LTE (E-UTRA) base station (eNB) is a master node (MN), and an NR base station (gNB) is a secondary node (SN). In the NE-DC, an NR base station (gNB) is MN, and an LTE (E-UTRA) base station (eNB) is SN.

The radio communication system 1 may support dual connectivity between a plurality of base stations in the same RAT (for example, dual connectivity in which both MN and SN are NR base stations (gNB) (NR-NR dual connectivity (NN-DC)).

The radio communication system 1 may include a base station 11 that forms a macro cell C1 with a relatively wide coverage, and base stations 12 (12a to 12c) that are disposed within the macro cell C1 and that form small cells C2 narrower than the macro cell C1. The user terminal 20 may be positioned in at least one cell. The arrangement, number, and the like, of cells and the user terminals 20 are not limited to the aspects illustrated in the drawings. Hereinafter, the base stations 11 and 12 will be collectively referred to as base stations 10 unless specified otherwise.

The user terminal 20 may be connected to at least one of the plurality of base stations 10. The user terminal 20 may use at least one of carrier aggregation (CA) using a plurality of component carriers (CC) or dual connectivity (DC).

Each CC may be included in at least one of a first frequency range 1 (FR1) and a second frequency range 2 (FR2). The macro cell C1 may be included in FR1, and the small cell C2 may be included in FR2. For example, FR1 may be a frequency range of 6 GHz or less (sub-6 GHz), and FR2 may be a frequency range higher than 24 GHz (above-24 GHz). Note that the frequency ranges, definitions, and the like, of FR1 and FR2 are not limited thereto, and, for example, FR1 may correspond to a frequency range higher than FR2.

Further, the user terminal 20 may perform communication in each CC using at least one of time division duplex (TDD) or frequency division duplex (FDD).

The plurality of base stations (for example, RRHs) 10 may be connected by wire (for example, an optical fiber, an X2 interface, or the like, in compliance with common public radio interface (CPRI)) or wirelessly (for example, NR communication). For example, in a case where NR communication is used as a backhaul between the base stations 11 and 12, the base station 11 corresponding to a higher-level station may be referred to as an integrated access backhaul (IAB) donor, and the base station 12 corresponding to a relay station (relay) may be referred to as an IAB node.

The base station 10 may be connected to a core network 30 via another base station 10 or directly. The core network 30 may include, for example, at least one of evolved packet core (EPC), 5G core network (5GCN), next generation core (NGC), and the like.

The user terminal 20 may be a terminal corresponding to at least one of communication methods such as LTE, LTE-A, and 5G.

In the radio communication system 1, a radio access method based on orthogonal frequency division multiplexing (OFDM) may be used. For example, in at least one of downlink (DL) or uplink (UL), cyclic prefix OFDM (CP-OFDM), discrete Fourier transform spread OFDM (DFT-s-OFDM), orthogonal frequency division multiple access (OFDMA), single carrier frequency division multiple access (SC-FDMA), and the like, may be used.

The radio access method may be referred to as a waveform. Note that in the radio communication system 1, another radio access method (for example, another single carrier transmission method or another multi-carrier transmission method) may be used as the UL and DL radio access method.

In the radio communication system 1, as a downlink channel, a physical downlink shared channel (PDSCH) shared by each user terminal 20, a physical broadcast channel (PBCH), a physical downlink control channel (PDCCH), or the like, may be used.

Further, in the radio communication system 1, as an uplink channel, a physical uplink shared channel (PUSCH) shared by each user terminal 20, a physical uplink control channel (PUCCH), a physical random access channel (PRACH), or the like, may be used.

User data, higher layer control information, and a system information block (SIB), and the like, are transmitted by the PDSCH. The PUSCH may transmit the user data, higher layer control information, and the like. Further, the PBCH may transmit a master information block (MIB).

The PDCCH may transmit lower layer control information. The lower layer control information may include, for example, downlink control information (DCI) including scheduling information of at least one of the PDSCH or the PUSCH.

Note that DCI that schedules the PDSCH may be referred to as DL assignment, DL DCI, or the like, and DCI that schedules the PUSCH may be referred to as UL grant, UL DCI, or the like. Note that the PDSCH may be read as DL data, and the PUSCH may be read as UL data.

A control resource set (CORESET) and a search space may be used to detect the PDCCH. The CORESET corresponds to a resource that searches for DCI. The search space corresponds to a search area and a search method for PDCCH candidates. One CORESET may be associated with one or more search spaces. The UE may monitor the CORESET associated with a certain search space on the basis of search space configuration.

One search space may correspond to a PDCCH candidate corresponding to one or a plurality of aggregation levels. One or more search spaces may be referred to as a search space set. Note that “search space”, “search space set”, “search space configuration”, “search space set configuration”, “CORESET”, “CORESET configuration”, and the like, in the present disclosure may be read each other.

Uplink control information (UCI) including at least one of channel state information (CSI), delivery confirmation information (which may be referred to as, for example, hybrid automatic repeat request acknowledgement (HARQ-ACK), ACK/NACK, or the like), scheduling request (SR), and the like, may be transmitted by the PUCCH. By means of the PRACH, a random access preamble for establishing a connection with a cell may be transmitted.

Note that in the present disclosure, downlink, uplink, and the like, may be expressed without “link”. Further, various channels may be expressed without adding “physical” at the beginning thereof.

In the radio communication system 1, a synchronization signal (SS), a downlink reference signal (DL-RS), and the like, may be transmitted. In the radio communication systems 1, a cell-specific reference signal (CRS), a channel state information reference signal (CSI-RS), a demodulation reference signal (DMRS), a positioning reference signal (PRS), a phase tracking reference signal (PTRS), and the like, may be transmitted as the DL-RS.

The synchronization signal may be, for example, at least one of a primary synchronization signal (PSS) or a secondary synchronization signal (SSS). A signal block including the SS (PSS or SSS) and the PBCH (and the DMRS for the PBCH) may be referred to as an SS/PBCH block, an SS block (SSB), or the like. Note that the SS, the SSB, or the like, may also be referred to as a reference signal.

Further, in the radio communication system 1, a sounding reference signal (SRS), a demodulation reference signal (DMRS), and the like, may be transmitted as an uplink reference signal (UL-RS). Note that, DMRSs may be referred to as “user terminal-specific reference signals (UE-specific Reference Signals)”.

(Base Station)

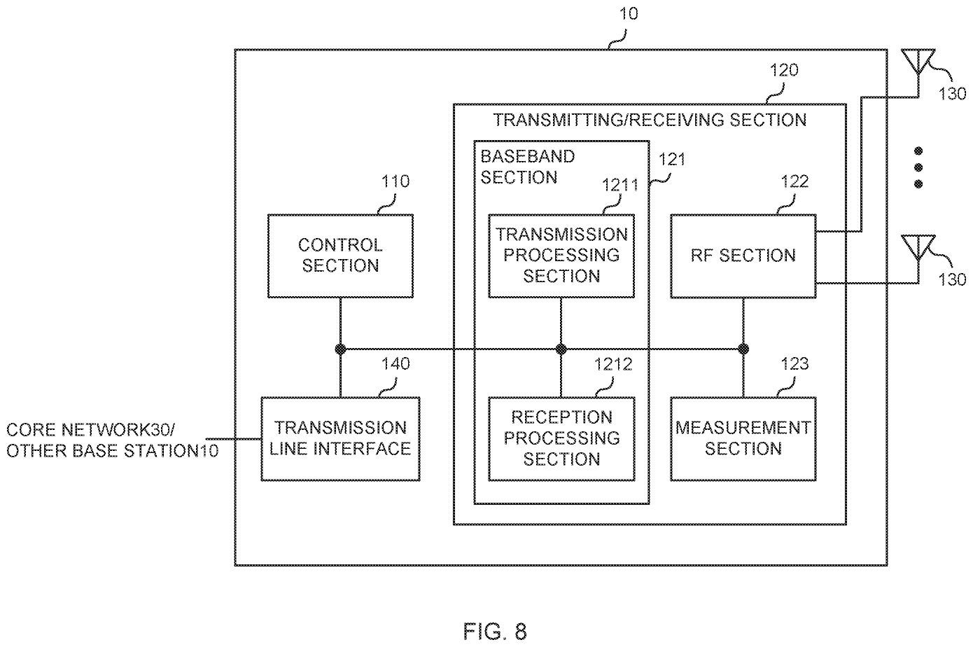

FIG. 8 is a view illustrating an example of a configuration of the base station according to one embodiment. The base station 10 includes a control section 110, a transmission/reception section 120, a transmission/reception antenna 130, and a transmission line interface 140. Note that one or more of the control sections 110, one or more of the transmission/reception sections 120, one or more of the transmission/reception antennas 130, and one or more of the transmission line interfaces 140 may be included.

Note that, although this example primarily indicates functional blocks of characteristic parts of the present embodiment, it may be assumed that the base station 10 has other functional blocks that are necessary for radio communication as well. Part of processing of each section described below may be omitted.

The control section 110 controls the entire base station 10. The control section 110 can be constituted by a controller, a control circuit, or the like, which is described based on common recognition in the technical field to which the present disclosure relates.

The control section 110 may control signal generation, scheduling (for example, resource allocation or mapping), and the like. The control section 110 may control transmission/reception, measurement, and the like, using the transmission/reception section 120, the transmission/reception antenna 130, and the transmission line interface 140. The control section 110 may generate data to be transmitted as a signal, control information, a sequence, and the like, and may forward the data, the control information, the sequence, and the like, to the transmission/reception section 120. The control section 110 may perform call processing (such as configuration or release) of a communication channel, management of the state of the base station 10, and management of a radio resource.

The transmission/reception section 120 may include a baseband section 121, a radio frequency (RF) section 122, and a measurement section 123. The baseband section 121 may include a transmission processing section 1211 and a reception processing section 1212. The transmission/reception section 120 can be constituted by a transmitter/receiver, an RF circuit, a base band circuit, a filter, a phase shifter, a measurement circuit, a transmission/reception circuit, and the like, which are described based on common recognition in the technical field to which the present disclosure relates.

The transmission/reception section 120 may be constituted as an integrated transmission/reception section, or may be constituted by a transmission section and a reception section. The transmission section may include the transmission processing section 1211 and the RF section 122. The reception section may be constituted by the reception processing section 1212, the RF section 122, and the measurement section 123.

The transmission/reception antenna 130 can be constituted by an antenna described based on common recognition in the technical field to which the present disclosure relates, for example, an array antenna.

The transmission/reception section 120 may transmit the above-described downlink channel, synchronization signal, downlink reference signal, and the like. The transmission/reception section 120 may receive the above-described uplink channel, uplink reference signal, and the like.

The transmission/reception section 120 may form at least one of a Tx beam and a reception beam by using digital beam forming (for example, precoding), analog beam forming (for example, phase rotation), and the like.

The transmission/reception section 120 (transmission processing section 1211) may perform packet data convergence protocol (PDCP) layer processing, radio link control (RLC) layer processing (for example, RLC retransmission control), medium access control (MAC) layer processing (for example, HARQ retransmission control), and the like, for example, on data or control information acquired from the control section 110 to generate a bit string to be transmitted.

The transmission/reception section 120 (transmission processing section 1211) may perform transmission processing such as channel encoding (which may include error correcting coding), modulation, mapping, filtering processing, discrete Fourier transform (DFT) processing (if necessary), inverse fast Fourier transform (IFFT) processing, precoding, or digital-analog transform on the bit string to be transmitted, and may output a base band signal.

The transmission/reception section 120 (RF section 122) may perform modulation to a radio frequency band, filtering processing, amplification, and the like, on the base band signal, and may transmit a signal in the radio frequency band via the transmission/reception antenna 130.

Meanwhile, the transmission/reception section 120 (RF section 122) may perform amplification, filtering processing, demodulation to a base band signal, and the like, on the signal in the radio frequency band received by the transmission/reception antenna 130.

The transmission/reception section 120 (reception processing section 1212) may apply reception processing such as analog-digital transform, fast Fourier transform (FFT) processing, inverse discrete Fourier transform (IDFT) processing (if necessary), filtering processing, demapping, demodulation, decoding (which may include error correction decoding), MAC layer processing, RLC layer processing, or PDCP layer processing on the acquired base band signal to acquire user data, and the like.

The transmission/reception section 120 (measurement section 123) may perform measurement on the received signal. For example, the measurement section 123 may perform radio resource management (RRM), channel state information (CSI) measurement, and the like, on the basis of the received signal. The measurement section 123 may measure received power (for example, reference signal received power (RSRP)), received quality (for example, reference signal received quality (RSRQ), a signal to interference plus noise ratio (SINR), a signal to noise ratio (SNR)), signal strength (for example, received signal strength indicator (RSSI)), propagation path information (for example, CSI), and the like. The measurement result may be output to the control section 110.

The transmission line interface 140 may transmit/receive a signal (backhaul signaling) to and from an apparatus included in the core network 30, other base stations 10, and the like, and may acquire, transmit, and the like, user data (user plane data), control plane data, and the like, for the user terminal 20.

Note that the transmission section and the reception section of the base station 10 in the present disclosure may be constituted by at least one of the transmission/reception section 120, the transmission/reception antenna 130, and the transmission line interface 140.

The transmission/reception section 120 may transmit information related to a downlink shared channel (PDSCH) by semi-persistent scheduling (SPS) in which transmission is not performed, using downlink control information (DCI). The control section 110 may control reception of hybrid automatic repeat request acknowledgement (HARQ-ACK) information for the PDSCH on the basis of the DCI.

The transmission/reception section 120 may transmit at least one of one or more first downlink shared channels (PDSCH) by semi-persistent scheduling in which transmission is performed, one or more second PDSCH to be dynamically scheduled by downlink control information (DCI), or information regarding a third PDSCH by semi-persistent scheduling in which transmission is not performed. The control section 110 may perform control to receive at least one of one or more first hybrid automatic repeat request acknowledgements (HARQ-ACKs) for the one or more first PDSCH or one or more second HARQ-ACKs for the one or more second PDSCH by using a channel to be used for HARQ-ACK transmission for the third PDSCH (fourth embodiment).

(User Terminal)

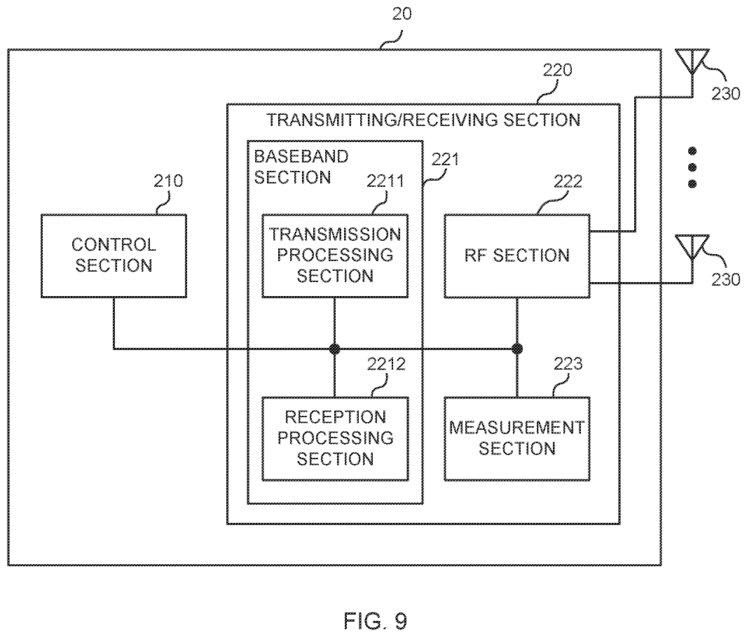

FIG. 9 is a view illustrating an example of a configuration of the user terminal according to one embodiment. The user terminal 20 includes a control section 210, a transmission/reception section 220, and a transmission/reception antenna 230. Note that one or more of the control sections 210, one or more of the transmission/reception sections 220, and one or more of the transmission/reception antennas 230 may be included.

Note that, although this example mainly describes a functional block which is a characteristic part of the present embodiment, it may be assumed that the user terminal 20 also has another functional block necessary for radio communication. Part of processing of each section described below may be omitted.

The control section 210 controls the entire user terminal 20. The control section 210 can be constituted by a controller, a control circuit, or the like, which is described on the basis of common recognition in the technical field to which the present disclosure relates.

The control section 210 may control signal generation, mapping, and the like. The control section 210 may control transmission/reception, measurement, and the like, using the transmission/reception section 220 and the transmission/reception antenna 230. The control section 210 may generate data to be transmitted as a signal, control information, a sequence, and the like, and may transfer the data, the control information, the sequence, and the like, to the transmission/reception section 220.

The transmission/reception section 220 may include a baseband section 221, an RF section 222, and a measurement section 223. The baseband section 221 may include a transmission processing section 2211 and a reception processing section 2212. The transmission/reception section 220 can be constituted by a transmitter/receiver, an RF circuit, a baseband circuit, a filter, a phase shifter, a measurement circuit, a transmission/reception circuit, and the like, which are described based on common recognition in the technical field to which the present disclosure relates.

The transmission/reception section 220 may be constituted as an integrated transmission/reception section, or may be constituted by a transmission section and a reception section. The transmission section may be constituted by the transmission processing section 2211 and the RF section 222. The reception section may be constituted by the reception processing section 2212, the RF section 222, and the measurement section 223.

The transmission/reception antenna 230 can be constituted by an antenna described based on common recognition in the technical field to which the present disclosure relates, for example, an array antenna.

The transmission/reception section 220 may receive the above-described downlink channel, synchronization signal, downlink reference signal, and the like. The transmission/reception section 220 may transmit the above-described uplink channel, uplink reference signal, and the like.

The transmission/reception section 220 may form at least one of a Tx beam and a reception beam by using digital beam forming (for example, precoding), analog beam forming (for example, phase rotation), and the like.

The transmission/reception section 220 (transmission processing section 2211) may perform PDCP layer processing, RLC layer processing (for example, RLC retransmission control), MAC layer processing (for example, HARQ retransmission control), and the like, for example, on data acquired from the control section 210 or control information to generate a bit string to be transmitted.

The transmission/reception section 220 (transmission processing section 2211) may perform transmission processing such as channel encoding (which may include error correcting coding), modulation, mapping, filtering processing, DFT processing (if necessary), IFFT processing, precoding, or digital-analog transform on a bit string to be transmitted, and may output a baseband signal.

Note that whether or not to apply DFT processing may be determined on the basis of configuration of transform precoding. In a case where transform precoding is enabled for a channel (for example, PUSCH), the transmission/reception section 220 (transmission processing section 2211) may perform DFT processing as the transmission processing in order to transmit the channel using a DFT-s-OFDM waveform. In a case where transform precoding is not enabled for a channel (for example, PUSCH), the transmission/reception section 220 (transmission processing section 2211) does not have to perform DFT processing as the transmission processing.

The transmission/reception section 220 (RF section 222) may perform modulation to a radio frequency band, filtering processing, amplification, and the like, on the baseband signal and may transmit a signal in the radio frequency band via the transmission/reception antenna 230.

Meanwhile, the transmission/reception section 220 (RF section 222) may perform amplification, filtering processing, demodulation to a baseband signal, and the like, on the signal in the radio frequency band received by the transmission/reception antenna 230.

The transmission/reception section 220 (reception processing section 2212) may acquire user data, and the like, by applying reception processing such as analog-digital transform, FFT processing, IDFT processing (if necessary), filtering processing, demapping, demodulation, decoding (which may include error correction decoding), MAC layer processing, RLC layer processing, or PDCP layer processing on the acquired baseband signal.

The transmission/reception section 220 (measurement section 223) may perform measurement on the received signal. For example, the measurement section 223 may perform RRM measurement, CSI measurement, and the like, on the basis of the received signal. The measurement section 223 may measure received power (for example, RSRP), received quality (for example, RSRQ, SINR, or SNR), signal strength (for example, RSSI), propagation path information (for example, CSI), and the like. The measurement result may be output to the control section 210.

Note that the transmission section and the reception section of the user terminal 20 in the present disclosure may be constituted by at least one of the transmission/reception section 220 or the transmission/reception antenna 230.

The transmission/reception section 220 may receive information related to a downlink shared channel (PDSCH) by semi-persistent scheduling (SPS) in which transmission is not performed, by using downlink control information (DCI). The control section 210 may control transmission of hybrid automatic repeat request acknowledgement (HARQ-ACK) information for the PDSCH on the basis of the DCI.

The DCI may be at least one of DCI for dynamically scheduling the PDSCH, DCI for releasing the PDSCH by the SPS, and DCI for making a notification of the PDSCH by the SPS in which the transmission is not performed (first embodiment).

The information may indicate at least one of an HARQ process number, an SPS configuration index, or a PDSCH transmission opportunity by SPS (second embodiment).

The control section 210 may assume that a channel for transmitting the HARQ-ACK is configured after a lapse of a specific period based on the subcarrier interval from a reception timing of a downlink control channel (PDCCH) including the DCI (third embodiment).

The transmission/reception section 220 may receive at least one of one or more first downlink shared channels (PDSCH) by semi-persistent scheduling in which transmission is performed, one or more second PDSCH dynamically scheduled by downlink control information (DCI), or information regarding a third PDSCH by semi-persistent scheduling in which transmission is not performed. The control section 210 may perform control to transmit at least one of one or more first hybrid automatic repeat request acknowledgements (HARQ-ACKs) for the one or more first PDSCH or one or more second HARQ-ACKs for the one or more second PDSCH by using a channel to be used for HARQ-ACK transmission for the third PDSCH (fourth embodiment).

The control section 210 may perform control to transmit the second HARQ-ACK regardless of reception of the first PDSCH and the third PDSCH (fourth embodiment).

In a case where all of the one or more first HARQ-ACKs are positive responses, the control section 210 may perform control not to transmit the one or more first HARQ-ACKs (fourth embodiment).

In a case where all of the one or more first HARQ-ACKs are negative acknowledgements, the control section 210 may perform control not to transmit the one or more first HARQ-ACKs (fourth embodiment).

(Hardware Configuration)

Note that the block diagrams that have been used to describe the above embodiments illustrate blocks in functional units. These functional blocks (components) may be implemented in arbitrary combinations of at least one of hardware or software. Further, the method for implementing each functional block is not particularly limited. In other words, each functional block may be implemented by a single apparatus physically or logically aggregated, or may be implemented by directly or indirectly connecting two or more physically or logically separate apparatuses (in a wired manner, a radio manner, or the like, for example) and using these apparatuses. The functional block may be implemented by combining the one apparatus or the plurality of apparatuses with software.

Here, the functions include, but are not limited to, judging, determination, decision, calculation, computation, processing, derivation, investigation, search, confirmation, reception, transmission, output, access, solution, selection, choosing, establishment, comparison, assumption, expectation, deeming, broadcasting, notifying, communicating, forwarding, configuring, reconfiguring, allocating, mapping, assigning, and so on. For example, a functional block (component) that has a transmission function may be referred to as a transmission section (transmitting unit), a transmitter, and the like. In any case, as described above, the implementation method is not particularly limited.

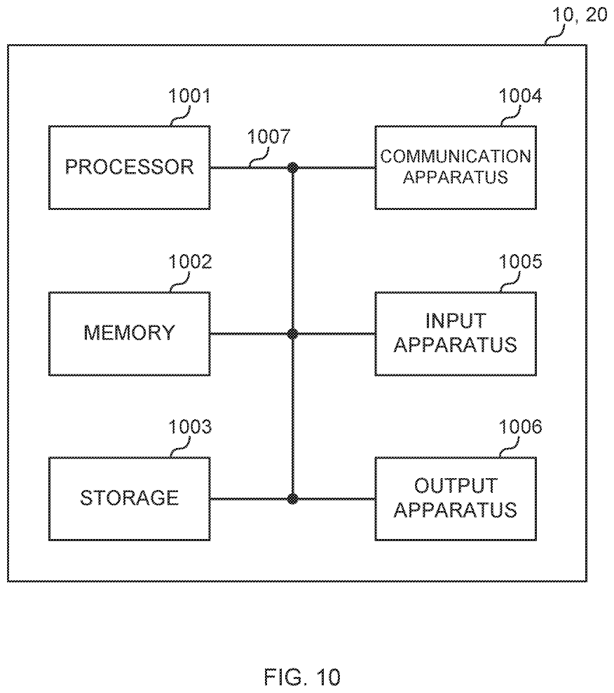

For example, the base station, the user terminal, and so on according to one embodiment of the present disclosure may function as a computer that executes the processing of the radio communication method of the present disclosure. FIG. 10 is a view illustrating an example of a hardware configuration of the base station and the user terminal according to one embodiment. Physically, the above-described base station 10 and user terminal 20 may be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the terms such as an apparatus, a circuit, an apparatus, a section, or a unit can be replaced with each other. The hardware configuration of the base station 10 and the user terminal 20 may be designed to include one or more of the apparatuses illustrated in the drawings, or may be designed not to include some apparatuses.

For example, although only one processor 1001 is illustrated, a plurality of processors may be provided. Further, the processing may be executed by one processor, or the processing may be executed by two or more processors simultaneously or sequentially, or using other methods. Note that the processor 1001 may be implemented with one or more chips.

Each function of the base station 10 and the user terminal 20 is implemented by, for example, reading predetermined software (program) into hardware such as the processor 1001 and the memory 1002, and by controlling the operation in the processor 1001, the communication in the communication apparatus 1004, and at least one of the reading or writing of data in the memory 1002 and the storage 1003.

The processor 1001 may control the whole computer by, for example, running an operating system. The processor 1001 may be implemented by a central processing unit (CPU) including an interface with peripheral equipment, a control apparatus, an operation apparatus, a register, and the like. For example, at least part of the above-described control section 110 (210), transmission/reception section 120 (220), and the like, may be implemented by the processor 1001.

Furthermore, the processor 1001 reads programs (program codes), software modules, data, and so on from at least one of the storage 1003 or the communication apparatus 1004 into the memory 1002, and executes various processing according to these. As the program, a program that causes a computer to execute at least part of the operation described in the above-described embodiment is used. For example, the control section 110 (210) may be implemented by a control program that is stored in the memory 1002 and operates in the processor 1001, and another functional block may be implemented similarly.

The memory 1002 is a computer-readable recording medium, and may include, for example, at least one of a read only memory (ROM), an erasable programmable ROM (EPROM), an electrically EPROM (EEPROM), a random access memory (RAM), or other appropriate storage media. The memory 1002 may be referred to as a register, a cache, a main memory (primary storage apparatus), and the like. The memory 1002 can store a program (program code), a software module, and the like, which are executable for implementing the radio communication method according to one embodiment of the present disclosure.

The storage 1003 is a computer-readable recording medium, and may include, for example, at least one of a flexible disk, a floppy (registered trademark) disk, a magneto-optical disk (for example, a compact disc ROM (CD-ROM) and the like), a digital versatile disk, a Blu-ray (registered trademark) disk), a removable disk, a hard disk drive, a smart card, a flash memory device (for example, a card, a stick, or a key drive), a magnetic stripe, a database, a server, or other appropriate storage media. The storage 1003 may be referred to as “secondary storage apparatus.”

The communication apparatus 1004 is hardware (transmission/reception device) for performing inter-computer communication via at least one of a wired network or a wireless network, and is referred to as, for example, a network device, a network controller, a network card, a communication module, and the like. The communication apparatus 1004 may include a high frequency switch, a duplexer, a filter, a frequency synthesizer, and the like in order to implement, for example, at least one of frequency division duplex (FDD) or time division duplex (TDD). For example, the transmission/reception section 120 (220), the transmission/reception antenna 130 (230), and the like described above may be implemented by the communication apparatus 1004. The transmission/reception section 120 (220) may be implemented by physically or logically separating the transmission section 120a (220a) and the reception section 120b (220b) from each other.

The input apparatus 1005 is an input device for receiving input from the outside (for example, a keyboard, a mouse, a microphone, a switch, a button, a sensor and so on). The output apparatus 1006 is an output device that performs output to the outside (for example, a display, a speaker, a light emitting diode (LED) lamp, or the like). Note that the input apparatus 1005 and the output apparatus 1006 may be provided in an integrated structure (for example, a touch panel).

Furthermore, these pieces of apparatus, including the processor 1001, the memory 1002, and so on are connected by the bus 1007 so as to communicate information. The bus 1007 may be formed with a single bus, or may be formed with buses that vary between pieces of apparatus.

Further, the base station 10 and the user terminal 20 may include hardware such as a microprocessor, a digital signal processor (DSP), an application specific integrated circuit (ASIC), a programmable logic device (PLD), or a field programmable gate array (FPGA), and some or all of the functional blocks may be implemented by using the hardware. For example, the processor 1001 may be implemented with at least one of these pieces of hardware.

### Modifications

Note that terms described in the present disclosure and terms necessary for understanding the present disclosure may be replaced with terms that have the same or similar meanings. For example, a channel, a symbol, and a signal (signal or signaling) may be replaced with each other. Further, the signal may be a message. The reference signal can be abbreviated as an RS, and may be referred to as a pilot, a pilot signal, and the like, depending on which standard applies. Further, a component carrier (CC) may be referred to as a cell, a frequency carrier, a carrier frequency, and the like.

A radio frame may be formed with one or more durations (frames) in the time domain. Each of the one or more periods (frames) included in the radio frame may be referred to as a subframe. Further, the subframe may include one or more slots in the time domain. A subframe may be a fixed time duration (for example, 1 ms) that is not dependent on numerology.

Here, the numerology may be a communication parameter used for at least one of transmission or reception of a certain signal or channel. For example, the numerology may indicate at least one of subcarrier spacing (SCS), a bandwidth, a symbol length, a cyclic prefix length, a transmission time interval (TTI), the number of symbols per TTI, a radio frame configuration, specific filtering processing performed by a transceiver in the frequency domain, or specific windowing processing performed by a transceiver in the time domain.

The slot may include one or more symbols in the time domain (orthogonal frequency division multiplexing (OFDM) symbols, single carrier frequency division multiple access (SC-FDMA) symbols, and the like). Also, a slot may be a time unit based on numerology.

A slot may include a plurality of mini slots. Each mini slot may include one or more symbols in the time domain. Further, the mini slot may be referred to as a subslot. Each mini slot may include fewer symbols than the slot. A PDSCH (or PUSCH) transmitted in a time unit larger than the mini slot may be referred to as “PDSCH (PUSCH) mapping type A”. A PDSCH (or PUSCH) transmitted using a mini slot may be referred to as “PDSCH (PUSCH) mapping type B”.

A radio frame, a subframe, a slot, a mini slot, and a symbol all represent the time unit in signal communication. The radio frame, the subframe, the slot, the mini slot, and the symbol may be called by other applicable names, respectively. Note that time units such as a frame, a subframe, a slot, a mini slot, and a symbol in the present disclosure may be replaced with each other.

For example, one subframe may be referred to as TTI, a plurality of consecutive subframes may be referred to as TTI, or one slot or one mini slot may be referred to as TTI. That is, at least one of the subframe or the TTI may be a subframe (1 ms) in the existing LTE, may be a period shorter than 1 ms (for example, one to thirteen symbols), or may be a period longer than 1 ms. Note that the unit to represent the TTI may be referred to as a “slot”, a “mini slot”, and so on, instead of a “subframe”.

Here, a TTI refers to the minimum time unit of scheduling in radio communication, for example. For example, in the LTE system, a base station performs scheduling to allocate radio resources (a frequency bandwidth, transmission power, and the like that can be used in each user terminal) to each user terminal in TTI units. Note that the definition of TTIs is not limited to this.

The TTI may be the transmission time unit of channel-encoded data packets (transport blocks), code blocks, codewords, and so on, or may be the unit of processing in scheduling, link adaptation, and so on. Note that when TTI is given, a time interval (for example, the number of symbols) in which the transport blocks, the code blocks, the codewords, and the like are actually mapped may be shorter than TTI.

Note that, when one slot or one mini slot is referred to as a “TTI”, one or more TTIs (that is, one or more slots or one or more mini slots) may be the minimum time unit of scheduling. Also, the number of slots (the number of mini slots) to constitute this minimum time unit of scheduling may be controlled.

TTI having a period of 1 ms may be referred to as usual TTI (TTI in 3GPP Rel. 8 to 12), normal TTI, long TTI, a usual subframe, a normal subframe, a long subframe, a slot, or the like. A TTI that is shorter than the usual TTI may be referred to as “shortened TTI”, “short TTI”, “partial TTI” (or “fractional TTI”), “shortened subframe”, “short subframe”, “mini slot”, “sub-slot”, “slot”, or the like.

Note that a long TTI (for example, a normal TTI, a subframe, etc.) may be replaced with a TTI having a time duration exceeding 1 ms, and a short TTI (for example, a shortened TTI) may be replaced with a TTI having a TTI duration less than the TTI duration of a long TTI and not less than 1 ms.

A resource block (RB) is the unit of resource allocation in the time domain and the frequency domain, and may include one or more contiguous subcarriers in the frequency domain. The number of subcarriers included in the RB may be the same regardless of the numerology, and may be twelve, for example. The number of subcarriers included in the RB may be determined based on numerology.

Also, an RB may include one or more symbols in the time domain, and may be one slot, one mini slot, one subframe, or one TTI in length. One TTI, one subframe, and the like may be each formed with one or more resource blocks.

Note that one or more RBs may be referred to as a physical resource block (PRB), a sub-carrier group (SCG), a resource element group (REG), a PRB pair, an RB pair, and the like.

Furthermore, a resource block may include one or more resource elements (REs). For example, one RE may be a radio resource field of one subcarrier and one symbol.

A bandwidth part (BWP) (which may be referred to as a partial bandwidth or the like) may represent a subset of contiguous common resource blocks (RBs) for a certain numerology in a certain carrier. Here, the common RB may be specified by the index of the RB based on a common reference point of the carrier. The PRB may be defined in a BWP and numbered within that BWP.

The BWP may include a BWP for UL (UL BWP) and a BWP for DL (DL BWP). For the UE, one or more BWPs may be configured within one carrier.

At least one of the configured BWPs may be active, and the UE does not need to assume to transmit or receive a predetermined signal/channel outside the active BWP. Note that “cell”, “carrier”, and the like, in the present disclosure may be replaced with “BWP”.

Note that the structures of radio frames, subframes, slots, mini slots, symbols and so on described above are merely examples. For example, configurations such as the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, the symbol length, the length of cyclic prefix (CP), and the like, can be variously changed.

Furthermore, the information and parameters described in the present disclosure may be represented in absolute values, represented in relative values with respect to given values, or represented using other corresponding information. For example, a radio resource may be specified by a predetermined index.

The names used for parameters and so on in the present disclosure are in no respect limiting. Further, any mathematical expression or the like that uses these parameters may differ from those explicitly disclosed in the present disclosure. Since various channels (PUCCH, PDCCH, and the like) and information elements can be identified by any suitable names, various names allocated to these various channels and information elements are not restrictive names in any respect.

The information, signals, and the like described in the present disclosure may be represented by using a variety of different technologies. For example, data, instructions, commands, information, signals, bits, symbols, and chips, all of which may be referenced throughout the herein-contained description, may be represented by voltages, currents, electromagnetic waves, magnetic fields or particles, optical fields or photons, or any combination of these.

Also, information, signals, and the like can be output at least either from higher layers to lower layers, or from lower layers to higher layers. Information, signals, and so on may be input and output via a plurality of network nodes.

The information, signals, and so on that are input and/or output may be stored in a specific location (for example, in a memory), or may be managed in a control table. The information, signals, and the like to be input and output can be overwritten, updated, or appended. The output information, signals, and the like, may be deleted. The information, signals, and so on that are input may be transmitted to other pieces of apparatus.

Notification of information may be performed not only by using the aspects/embodiments described in the present disclosure but also using another method. For example, the notification of information in the present disclosure may be performed by using physical layer signaling (for example, downlink control information (DCI) or uplink control information (UCI)), higher layer signaling (for example, radio resource control (RRC) signaling, broadcast information (master information block (MIB)), system information block (SIB), or the like), or medium access control (MAC) signaling), another signal, or a combination thereof.

Note that the physical layer signaling may be referred to as Layer 1/Layer 2 (L1/L2) control information (L1/L2 control signal), L1 control information (L1 control signal), and the like. Further, the RRC signaling may be referred to as an RRC message, and may be, for example, an RRC connection setup message, an RRC connection reconfiguration message, and the like. Further, notification of the MAC signaling may be performed using, for example, an MAC control element (CE).

Also, reporting of predetermined information (for example, reporting of information to the effect that “X holds”) does not necessarily have to be sent explicitly, and can be sent implicitly (for example, by not reporting this piece of information, by reporting another piece of information, and so on).

Decisions may be made in values represented by one bit (0 or 1), may be made in Boolean values that represent true or false, or may be made by comparing numerical values (for example, comparison against a predetermined value).

Software, whether referred to as “software”, “firmware”, “middleware”, “microcode”, or “hardware description language”, or called by other names, should be interpreted broadly, to mean instructions, instruction sets, code, code segments, program codes, programs, subprograms, software modules, applications, software applications, software packages, routines, subroutines, objects, executable files, execution threads, procedures, functions, and so on.

Also, software, commands, information and so on may be transmitted and received via communication media. For example, when software is transmitted from a website, a server, or another remote source by using at least one of a wired technology (coaxial cable, optical fiber cable, twisted pair, digital subscriber line (DSL), or the like) or a wireless technology (infrared rays, microwaves, and the like), at least one of the wired technology or the wireless technology is included within the definition of a transmission medium.

The terms “system” and “network” used in the present disclosure may be used interchangeably. The “network” may mean an apparatus (for example, a base station) included in the network.

In the present disclosure, terms such as “precoding”, “precoder”, “weight (precoding weight)”, “quasi-co-location (QCL)”, “transmission configuration indication state (TCI state)”, “spatial relation”, “spatial domain filter”, “transmit power”, “phase rotation”, “antenna port”, “antenna port group”, “layer”, “number of layers”, “rank”, “resource”, “resource set”, “resource group”, “beam”, “beam width”, “beam angle”, “antenna”, “antenna element”, and “panel” can be used interchangeably.

In the present disclosure, terms such as “base station (BS)”, “radio base station”, “fixed station”, “NodeB”, “eNodeB (eNB)”, “gNodeB (gNB)”, “access point”, “transmission point (TP)”, “reception point (RP)”, “transmission/reception point (TRP)”, “panel”, “cell”, “sector”, “cell group”, “carrier”, and “component carrier”, can be used interchangeably. The base station may be referred to as a term such as a macro cell, a small cell, a femto cell, or a pico cell.

The base station can accommodate one or more (for example, three) cells. In a case where the base station accommodates a plurality of cells, the entire coverage area of the base station can be partitioned into a plurality of smaller areas, and each smaller area can provide communication services through a base station subsystem (for example, small base station for indoors (remote radio head (RRH))). The term “cell” or “sector” refers to a part or the whole of a coverage area of at least one of the base station or the base station subsystem that performs a communication service in this coverage.

In the present disclosure, the terms such as “mobile station (MS)”, “user terminal”, “user equipment (UE)”, and “terminal” can be used interchangeably.

A mobile station may be referred to as a subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, or some other suitable terms.

At least one of a base station or a mobile station may be referred to as a transmitting apparatus, a receiving apparatus, a radio communication apparatus, or the like. Note that at least one of the base station or the mobile station may be a device mounted on a moving body, a moving body itself, and the like. The moving body may be a transportation (for example, a car, an airplane, or the like), an unmanned moving body (for example, a drone, an autonomous car, or the like), or a (manned or unmanned) robot. Note that at least one of the base station or the mobile station also includes an apparatus that does not necessarily move during a communication operation. For example, at least one of the base station or the mobile station may be an Internet of Things (IoT) device such as a sensor.

Further, the base station in the present disclosure may be replaced with the user terminal. For example, each aspect/embodiment of the present disclosure may be applied to a configuration in which communication between the base station and the user terminal is replaced with communication among a plurality of user terminals (which may be referred to as, for example, device-to-device (D2D), vehicle-to-everything (V2X), and the like). In this case, the user terminal 20 may have the function of the above-described base station 10. Further, terms such as “uplink” and “downlink” may be replaced with terms corresponding to communication between terminals (for example, “side”). For example, an uplink channel and a downlink channel may be replaced with a side channel.

Likewise, the user terminal in the present disclosure may be replaced with a base station. In this case, the base station 10 may be configured to have the functions of the user terminal 20 described above.

In the present disclosure, an operation performed by the base station may be performed by an upper node thereof in some cases. In a network including one or more network nodes with base stations, it is clear that various operations performed for communication with a terminal can be performed by a base station, one or more network nodes (examples of which include but are not limited to mobility management entity (MME) and serving-gateway (S-GW)) other than the base station, or a combination thereof.

The aspects/embodiments illustrated in the present disclosure may be used individually or in combinations, which may be switched depending on the mode of implementation. Further, the order of processing procedures, sequences, flowcharts, and the like of the aspects/embodiments described in the present disclosure may be re-ordered as long as there is no inconsistency. For example, regarding the methods described in the present disclosure, elements of various steps are presented using an illustrative order, and are not limited to the presented particular order.

Each aspect/embodiment described in the present disclosure may be applied to a system using long term evolution (LTE), LTE-advanced (LTE-A), LTE-beyond (LTE-B), SUPER 3G, IMT-Advanced, 4th generation mobile communication system (4G), 5th generation mobile communication system (5G), 6th generation mobile communication system (6G), xth generation mobile communication system (xG) (x is, for example, an integer or decimal), future radio access (FRA), new radio access technology (RAT), new radio (NR), new radio access (NX), future generation radio access (FX), global system for mobile communications (GSM (registered trademark)), CDMA 2000, ultra mobile broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), or another appropriate radio communication method, a next generation system expanded on the basis of these, and the like. Further, a plurality of systems may be combined and applied (for example, a combination of LTE or LTE-A and 5G, and the like).

The phrase “based on” as used in the present disclosure does not mean “based only on”, unless otherwise specified. In other words, the phrase “based on” means both “based only on” and “based at least on”.

Reference to elements with designations such as “first”, “second”, and so on as used in the present disclosure does not generally limit the number/quantity or order of these elements. These designations can be used in the present disclosure, as a convenient way of distinguishing between two or more elements. In this way, reference to the first and second elements does not imply that only two elements may be employed, or that the first element must precede the second element in some way.

The terms “judging (determining)” as used in the present disclosure may encompass a wide variety of operations. For example, “judging (determining)” may be interpreted to mean making judgements and determinations related to judging, calculating, computing, processing, deriving, investigating, looking up, search, inquiry (for example, looking up in a table, database, or another data structure), ascertaining, and so on.

Furthermore, to “judge” and “determine” as used herein may be interpreted to mean making judgements and determinations related to receiving (for example, receiving information), transmitting (for example, transmitting information), inputting, outputting, accessing (for example, accessing data in a memory), and so on.

In addition, to “judge” and “determine” as used herein may be interpreted to mean making judgements and determinations related to resolving, selecting, choosing, establishing, comparing, and so on. In other words, to “judge” and “determine” as used herein may be interpreted to mean making judgements and determinations related to some operation.

In addition, to “judge (determine)” may be replaced with “assuming”, “expecting”, “considering”, and so on.

The terms “connected” and “coupled”, or any variation thereof used in the present disclosure mean all direct or indirect connections or coupling between two or more elements, and can include the presence of one or more intermediate elements between two elements that are “connected” or “coupled” to each other. The coupling or connection between the elements may be physical, logical, or a combination of these. For example, “connection” may be replaced with “access”.

In the present disclosure, when two elements are connected, these elements may be considered to be “connected” or “coupled” to each other by using one or more electrical wires, cables, printed electrical connections, and the like, and by using, as some non-limiting and non-inclusive examples, electromagnetic energy having a wavelength in the radio frequency domain, microwave domain, and optical (both visible and invisible) domain, and the like.

In the present disclosure, the phrase “A and B are different” may mean “A and B are different from each other”. Note that the phrase may mean that “A and B are different from C”. The terms such as “leave”, “coupled”, and the like may be interpreted similarly to “different”.

When “include”, “including”, and variations thereof are used in the present disclosure, these terms are intended to be inclusive similarly to the term “comprising”. The term “or” used in the present disclosure is intended not to be exclusive-OR.

In the present disclosure, when English articles such as “a”, “an”, and “the” are added in translation, the present disclosure may include the plural forms of nouns that follow these articles.

Although the invention according to the present disclosure has been described in detail above, it is obvious to a person skilled in the art that the invention according to the present disclosure is by no means limited to the embodiments described in the present disclosure. The invention according to the present disclosure can be embodied with various corrections and in various modified aspects, without departing from the spirit and scope of the invention defined on the basis of the description of claims. Consequently, the description of the present disclosure is provided only for the purpose of explaining examples, and should by no means be construed to limit the invention according to the present disclosure in any way.

1. A terminal comprising:
a reception section configured to receive information related to a downlink shared channel (PDSCH) by semi-persistent scheduling (SPS) in which transmission is not performed, using downlink control information (DCI); and
a control section configured to control transmission of a hybrid automatic repeat request acknowledgement (HARQ-ACK) for the PDSCH by the SPS on the basis of the information.

2. The terminal according to claim 1, wherein the DCI is at least one of DCI for dynamically scheduling a PDSCH, DCI for releasing a PDSCH by SPS, or DCI for making a notification of a PDSCH by SPS in which transmission is not performed.

3. The terminal according to claim 1, wherein the information indicates at least one of an HARQ process number, an SPS configuration index or a PDSCH transmission opportunity by SPS.

4. The terminal according to claim 1, wherein the control section assumes that a channel for transmitting the HARQ-ACK is configured after a lapse of a specific period based on a subcarrier interval from a reception timing of a downlink control channel (PDCCH) including the DCI.

5. A radio communication method of a terminal, comprising:
a step of receiving information related to a downlink shared channel (PDSCH) by semi-persistent scheduling (SPS) in which transmission is not performed, using downlink control information (DCI); and
a step of controlling transmission of a hybrid automatic repeat request acknowledgement (HARQ-ACK) for the PDSCH by the SPS on the basis of the information.

6. A base station comprising:
a transmission section configured to transmit information related to a downlink shared channel (PDSCH) by semi-persistent scheduling (SPS) in which transmission is not performed, using downlink control information (DCI); and
a control section configured to control reception of a hybrid automatic repeat request acknowledgement (HARQ-ACK) for the PDSCH by the SPS transmitted on the basis of the information.
